(19) United States
(12) Patent Application Publication
(10) Pub. No.: US 2025/0322450 A1
(43) Pub. Date: Oct. 16, 2025

(54) SYSTEM AND METHOD FOR PROVIDING REPAIR ESTIMATES

(71) Applicant: Paul Jerone Jones, Sanford, FL (US)

(72) Inventor: Paul Jerone Jones, Sanford, FL (US)

(21) Appl. No.: 19/172,438

(22) Filed: Apr. 7, 2025

Related U.S. Application Data
(60) Provisional application No. 63/632,626, filed on Apr. 11, 2024.

(51) Int. Cl. G06Q 30/08; G06Q 10/20; G06Q 30/0601

(52) U.S. Cl. CPC G06Q 30/08; G06Q 10/20; G06Q 30/0633; G06Q 30/0641

(57) ABSTRACT

A system and method for providing repair estimates includes the steps of establishing a platform for facilitating communication between a consumer operating a consumer interface device and a plurality of marketplace vendors each operating a vendor interface device. The platform includes functionality for allowing the consumer to upload a vehicular inspection report outlining a work request for a motor vehicle based on a physical inspection. The platform includes functionality for submitting the inspection report to a group of marketplace vendors who are pre-qualified to perform the requested work. The selected group is also based on consumer-defined criteria. The platform receives bids from interested marketplace vendors to perform the requested work and provides the bids to the customer for comparison. The platform includes functionality for the customer to select a winning bid to complete the requested work for the price contained in the winning bid.

### CROSS-REFERENCE TO RELATED APPLICATIONS

This application claims the benefit of U.S. Application Ser. No. 63/632,626 filed on Apr. 11, 2025, the contents of which are incorporated herein by reference.

### TECHNICAL FIELD

The present invention relates generally to the automotive repair industry, and more particularly to a system and method for allowing consumers to receive a plurality of competitive repair estimates based on a single submission.

### BACKGROUND

The statements in this section merely provide background information related to the present disclosure and may not constitute prior art.

When a motor vehicle needs to be repaired, most consumers will choose a repair shop based on its location and/or online reviews. To this end, the consumer will bring their vehicle to the selected shop, receive a repair estimate and (in most cases) proceed with the repairs at that shop without seeking secondary opinions. This is because the time and effort involved in taking the vehicle to multiple shops to be examined is a laborious and extremely time-consuming endeavor.

Although there are many online platforms where service providers advertise their services, none of these platforms allow multiple providers to share information when bidding on a repair without physically examining the vehicle in question. Accordingly, the inventor of the presently described invention has created a novel platform for allowing a user to upload a repair estimate from a repair shop that has physically inspected the vehicle, in order to allow other repair shops to review and bid to complete the needed repairs, thus eliminating the need for the consumer to physically bring the vehicle to multiple locations.

### SUMMARY OF THE INVENTION

The present invention is directed to a system and method for providing repair estimates. One embodiment of the present invention can include the steps of establishing a platform for facilitating communication between a consumer and a plurality of vendors. The platform can include functionality for allowing the consumer to upload a vehicular inspection report outlining an issue or work request for a motor vehicle based on a physical inspection.

In one embodiment, the platform can submit the inspection report to a group of marketplace vendors who are pre-qualified to perform the requested work. The group to receive the inspection report can be narrowed by the consumer based on criteria such as reviews, distance, certifications, and warranty, among other criteria.

In one embodiment, the platform can receive bids from the marketplace vendors to perform the requested work. The bids can be provided to the customer individually or cumulatively to permit the customer to compare competing bids. Once the bids have been reviewed, the customer can select a winning bidder to complete the requested work for the price contained in the winning bid.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a schematic illustration of an exemplary system for providing repair estimates that is useful for understanding the inventive concepts disclosed herein.

FIG. 2 shows an exemplary flow diagram illustrating a method of providing repair estimates using the platform.

FIG. 3 shows an exemplary user interface of the platform, in accordance with one embodiment of the invention.

FIG. 4 shows another exemplary user interface of the platform, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described throughout this document, the terms “platform provider,” and “system administrator” are used interchangeably, to include any individual, group or legal entity that is overseeing, providing, and/or performing various aspects of the below described system and/or methodology.

As described herein, a “system user” and “consumer” are used interchangeably to describe any person or entity who utilizes the system to request quotes from a marketplace vendor for performing a desired service.

As described herein, a “marketplace vendor” describes any individual, group or legal entity who utilizes the system to review information provided by a system user, and to offer quotes on providing a requested service based on the reviewed information.

As will be appreciated by one skilled in the art, aspects of the present invention may be embodied as a system, method, and/or computer program product. Therefore, aspects of the present invention may take the form of an entirely hardware embodiment, or an embodiment combining software and hardware aspects that may all generally be referred to herein as a “unit”, “module,” “system”, or “feature.”

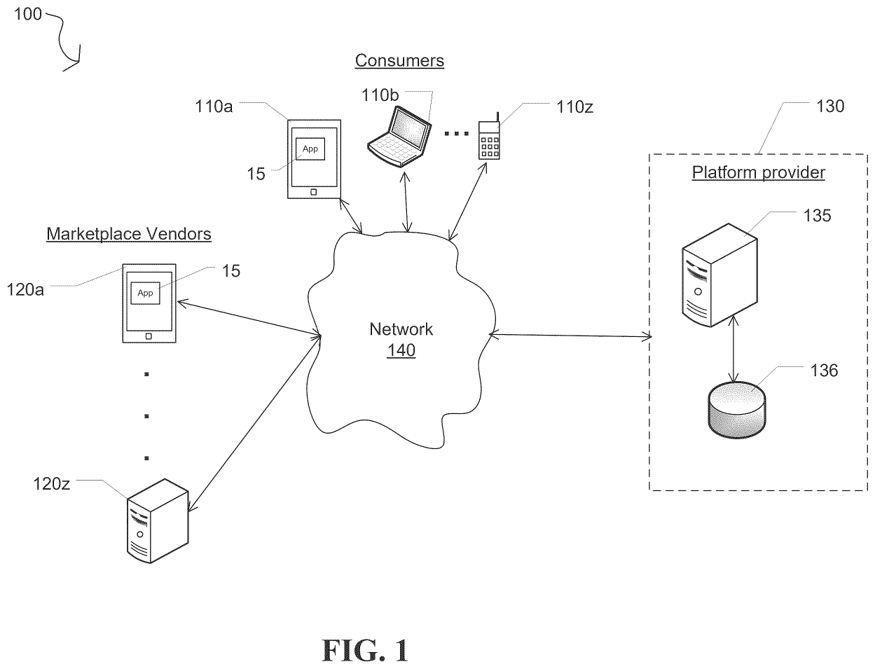

FIG. 1 is a schematic block diagram of an exemplary operating environment 100 in which the system may be implemented and arranged, in accordance with at least one embodiment described herein.

The system 100 can include, for example, any number of consumers each utilizing an interface device 110a-110z, and any number of marketplace vendors each utilizing an interface device 120a-120z, that are communicating with each other and a platform provider system 130 over a network 140.

As described herein, an interface device can include any type of processor-enabled device such as a computer, tablet, PDA, smart phone, smart watch, and other such components, for example, that can be operated by a human user.

To this end, consumers can utilize an interface device 110a-110z to upload one or more estimates received from a vendor such as a body shop, automotive repair facility, or dealership, for example, to the Platform Provider System. When so provided, marketplace vendors can utilize an interface device 120a-120z to view the uploaded estimates and can provide competing estimates/bids to perform the noted work for the consumer.

The platform provider system 130, according to one embodiment, can include one or more individual computing devices 135 that can be connected to one or more databases 136 on which various portions of the method can be performed.

One example of a database 136 for use herein can include one or more independent storage devices that can function to receive and store information for the performance of the method steps, and/or information such as product and services listings, pricing, communication protocols, tracking of orders and payment information. Several nonlimiting examples include various types of computer-readable storage mediums, such as semiconductor memory devices, e.g., DRAM, SRAM, EPROM, EEPROM, and flash memory devices, magnetic disks, e.g., internal hard disks or removable disks, for example.

The platform provider system 130 can also function to provide a central hub for controlling direct or indirect communication between the consumers and marketplace vendors utilizing the above-described interface devices through any number of different mediums such as the above noted website, for example, along with any number of secure and/or encrypted messaging and communication protocols. In this regard, one or more of the individual computing devices 135 of the platform provider system can comprise a web server, an email server, a communication server, and so forth, or the system can employ one or more single server-type devices which function to handle each of these processes.

The platform system 130 can also include functionality for providing one or more mobile application(s) 15 that can be downloaded onto an interface device. In this regard, the system can provide or generate any number of different display screens on each of the interface device(s) in order to provide consumers with the ability to view and research the marketplace vendors prior to accepting their bid.

Owing to the nature of the information to be shared across the system components, one or more of the platform system servers 135, can be constructed as a purpose-built device having dedicated and password protected internal or external storage mediums. These purpose-built devices can further include secure network interfaces to ensure that the purpose-built non-generic processor enabled devices perform the below described methodology in a completely secure manner that cannot be achieved through the use of off-the-shelf hardware. Such a feature being beneficial to ensure the secure transfer of information between various parties utilizing the system.

As described herein, the network 140 can include any type of transmission medium that facilitates any form of digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a wireless network (e.g., RAN, code-division multiple access (CDMA) network, time division multiple access (TDMA) network, global system for mobile communications (GSM) network), Bluetooth, Wi-Fi, or Personal Area Networks (PANs), Near Frequency Communication (NFC) network, and/or other circuit-based networks.

Information transfer over the network 140 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

A method of using the system will now be described. The below described methods are exemplary in nature to demonstrate the functionality of the system. To begin, each user (e.g., consumer and marketplace provider) can create a user account via the platform provider server to establish an account and be provided access to the system functionality. In one embodiment, the account information for each created user account can be maintained by the database 136, and can include, for example, personal information such as name, physical address, financial information (e.g., bank or credit card information), username, password, and email address, for example.

Once registered with the system, marketplace vendors can apply to provide competitive bids to consumers using the system. To this end, the platform provider can use any number of internal or third-party systems to authenticate the marketplace vendors such as performing a business or personal background check, online reviews, and certifications in the areas to which the vendor will be permitted to bid. For example, a paint and body shop would be permitted to bid only on automotive bodywork whereas an automotive repair shop would be permitted to bid only on repairs and not vice versa.

Once the marketplace vendor has successfully registered, the system can provide the vendor with any number of different tools for allowing them to receive and view repair estimates submitted by consumers, and to provide the consumer with a bid to perform the needed work.

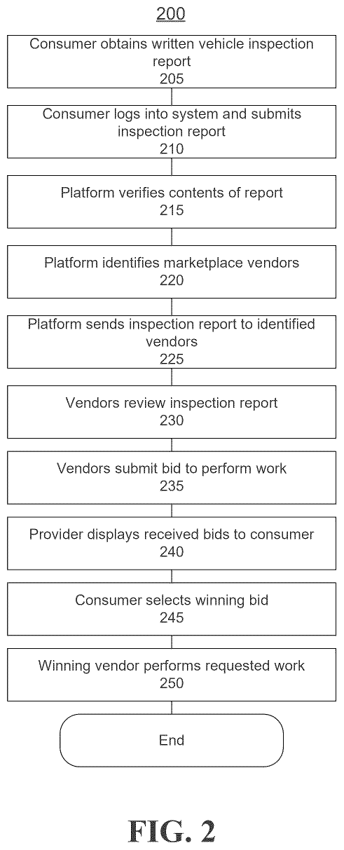

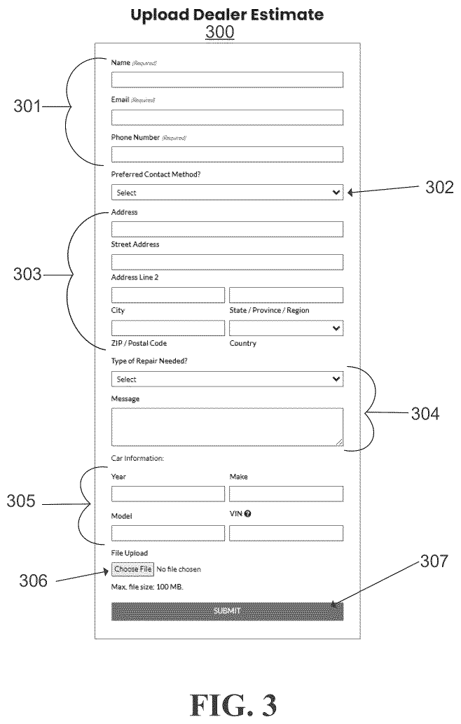

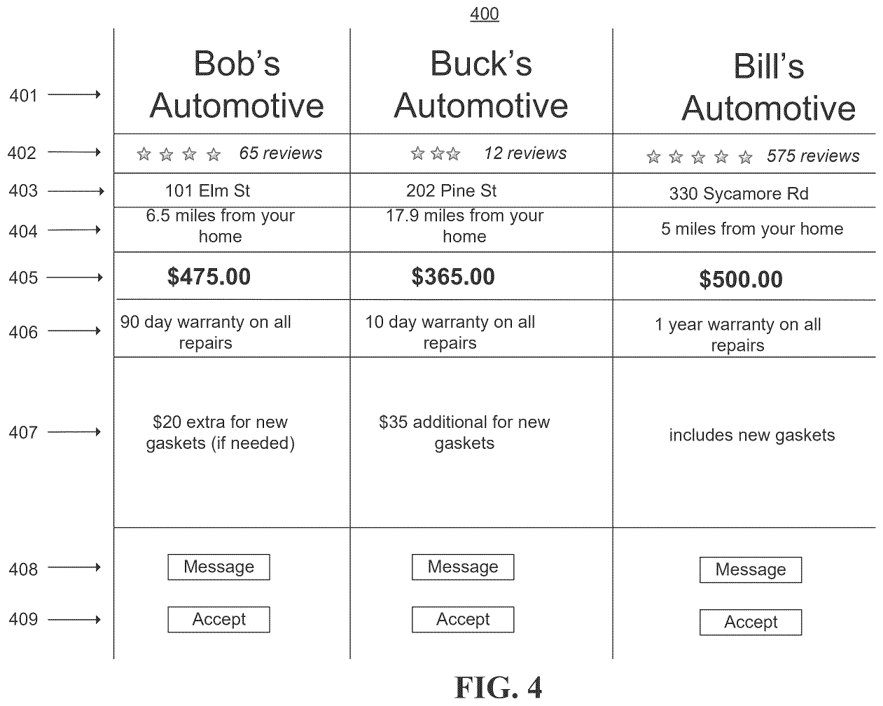

One exemplary method 200 of providing a repair estimate using the system 100 will now be described with respect to FIG. 2. Moreover, several exemplary presentation screens that can be generated by the platform provider 130 and delivered to the consumer interface device 110 via the mobile App 15 or through the system website are presented with respect to FIGS. 3-4.

Although described below with respect to particular steps and screens, this is for illustrative purposes only, as the methodology described herein can be performed in a different order than shown, and the presentation screens can include any number of additional information and features.

As shown at FIG. 2, the method 200 can begin at step 205 where a consumer can first obtain a primary written inspection report from an outside vendor for the consumer's vehicle. The inspection report will be based on the outside vendor's physical inspection of the vehicle and will outline the specific issues diagnosed by the vendor and the recommended repairs. The report may or may not contain pricing information from the outside vendor for performing the noted repairs. In either instance, the inspection report will be specific to the consumers vehicle and will contain identifying information such as the make and model of the vehicle, the VIN number and/or license plate information, for example.

Next, the consumer can log into the system to provide information about their vehicle and to upload a copy of the inspection report at step 210.

FIG. 3 illustrates one simplified and exemplary presentation screen 300 for allowing the consumer to upload the physical inspection estimate. As shown, the screen can include options for the user to provide their name and contact information 301, their preferred contact method 302 and their address information 303. It is noted that in most instances, the system will automatically populate this information for registered users. However, the platform provider may optionally allow non-registered consumers to utilize the system-such as through a free trial or other promotion, for example. In such instances, the user information would be populated by the user themself.

The system can also provide the user with options to select the type of repair needed and to provide any specific notes or messages at 304. In most instances, the user will be provided with options such as “Mechanical” “Interior” “Body Work” or “Other.” The system can also provide the user with options for listing information about the vehicle such as the Year, Make, Model and VIN number, for example at 305, and can provide the user with the option to upload and submit the inspection report at 306 and 307.

Returning to the method, at step 215 the platform provider system can evaluate the consumer submission to ensure the necessary information has been provided. If information is missing, the method will return to step 210, otherwise the method will proceed to step 220 where the platform provider can identify a listing of marketplace providers to receive the report.

The step of identifying marketplace providers to receive the report can be based on many different factors from both the Platform Provider and the Consumer. For example, the platform provider will only send the inspection report to vendors that are qualified (based on information in the registration step) to handle the repairs. To this end, an upholstery shop would not be sent the inspection report where the vehicle needs to be painted. Additionally, if the consumer stipulates they only want estimates from vendors within a set distance from their home, or from vendors that have 4 stars or more, for example, any vendors that do not meet the set criteria will not be provided with the report.

Next, the method can proceed to step 225 where the Platform Provider can send the uploaded inspection report to the listing of vendors identified at step 220. In the preferred embodiment, the report can be sent to each Vendors dashboard so as to appear directly on the system website or mobile application. Alternatively, or in addition to the above, the vendors may receive the inspection report via other means such as email, for example.

In either instance, each vendor can view the inspection report at step 230 to determine if they would like to provide a bid to the consumer to complete the work/repairs outlined in the report.

At step 235, each vendor can submit a bid to the consumer. As described herein, the bid can include a written offer to perform the needed work and the cost to be charged by the marketplace vendor. The bid can also include additional information such as any warranty to be provided pertaining to the repair, timeline for the repair (hours or days) and other information to allow the consumer to make an informed decision.

At step 240 the platform provider can display the received bids to the consumer. Although the system can send the bids directly to the consumer, in one embodiment, the platform provider can generate a display screen for allowing the consumer to see and compare the bids they have received.

FIG. 4 illustrates one simplified and exemplary presentation screen 400 for allowing the consumer to view and compare bids received to perform the repairs. As shown, the screen can include a side-by-side listing of the received bids and can include information such as the Marketplace Vendors name 401, Ratings 402, address 403, distance from Consumer 404, bid price 405, warranty information 406, and notes section 407. The system can also provide the Consumer with a MESSAGE tab 408 to communicate directly with a specific vendor. This tab can be used to activate the messaging features of the system to allow messages to appear on the vendor/consumer's dashboards or may open a window for allowing the parties to communicate via email, among others, for example. Lastly, the screen can provide an ACCEPT tab 409 where the consumer can accept the bid from the marketplace vendor.

Returning to the method, at step 245 the consumer can view the received bids and select their preferred shop by clicking the Accept tab. Upon accepting the bid, the consumer and marketplace vendor can schedule the day and time for the repair to be made and the vendor can complete the repair at step 250 for the price outlined in their bid.

Although described above with regard to performing repairs for automobiles, other embodiments are also contemplated. To this end, the inventive system can be used in any number of other industries for providing competitive bids on any type of work.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
establishing communication between a consumer interface device, a plurality of vendor interface devices and a platform system over a network;
providing, via the consumer interface device, information about a needed service to the platform system;
storing the provided information on a platform system database;
viewing the provided information on the plurality of vendor interface devices;
displaying a plurality of bids submitted by a group of the plurality of vendor interface devices to the consumer interface device;
selecting, via the consumer interface device, one of the plurality of bids; and
repairing a motor vehicle of a consumer operating the consumer interface device based on the provided information and the selected bid.

2. The method of claim 1, wherein the provided information includes a technical diagnosis of a vehicular problem of the motor vehicle of the consumer.

3. The method of claim 2, wherein the technical diagnosis is performed via a physical inspection of the vehicle.

4. The method of claim 3, wherein the repairing step is performed by a vendor operating the vendor interface device having the selected bid.

5. The method of claim 1, further comprising:
providing, via the platform system, a vehicle repair request menu for the consumer interface device.

6. The method of claim 5, wherein the vehicle repair request menu includes a consumer identification section.

7. The method of claim 5, wherein the vehicle repair request menu includes a consumer address section.

8. The method of claim 5, wherein the vehicle repair request menu includes a listing of pre-populated work requests.

9. The method of claim 5, wherein the vehicle repair request menu includes a vehicle identification section.

10. The method of claim 9, wherein the vehicle repair request menu includes a file upload option.

11. The method of claim 10, wherein the file upload option includes functionality for receiving a document containing a technical diagnosis from a physical inspection of the vehicle described in the vehicle identification section.
